(19) United States
(12) Patent Application Publication
(10) Pub. No.: US 2013/0076633 A1
(43) Pub. Date: Mar. 28, 2013

(54) INTEGRATED, PORTABLE COMPUTING AND ENTERTAINMENT DEVICE

(71) Applicant: CTX VIRTUAL TECHNOLOGIES, Baca Raton, FL (US)

(72) Inventors: David S. LITHWICK, Thornhill (CA); Clifford M. RHEE, Mississauga (CA)

(73) Assignee: CTX VIRTUAL TECHNOLOGIES, Baca Raton, FL (US)

(21) Appl. No.: 13/627,619

(22) Filed: Sep. 26, 2012

Related U.S. Application Data
(60) Provisional application No. 61/539,523, filed on Sep. 27, 2011.

(51) Int. Cl. G06F 3/02

(52) U.S. Cl. CPC G06F 3/0219
USPC 345/168

(57) ABSTRACT

A portable, integrated computing device, includes a PC board within a housing and a projector assembly. An input/output port is provided on the housing and operatively connected to the PC board. A display is located on a top portion of the housing. A virtual keyboard module projects an image of a keyboard on a surface. The unit can be turned on with a selectable actuator for turning on the device, to selectively operate the device as a projector, by connecting a source component to one of the at least one output port on the housing, and bypassing the PC board, in order to project an image through the lens of the projector assembly or to operate the device as a computing device, by powering the PC board, and by using either the projector for displaying images or using the display for displaying images, or both.

### CROSS-REFERENCE TO RELATED APPLICATION

This application claims the benefit of U.S. Provisional Patent Application Ser. No. 61/539,523 filed Sep. 27, 2011, the entirety of which is hereby incorporated herein by reference for all purposes.

### FIELD OF THE INVENTION

The present invention relates to an integrated, portable computing and entertainment device.

### DESCRIPTION OF THE PRIOR ART

Computing devices, in their various incarnations, are well known in the art. From desktop computers, to laptops, to netbooks, to touch pads, to smart phones, the personal computer has gained power and lost size over the years.

Smart phones are included in the above list because although they do not typically have the computing power of the other devices, they do enable a user to handle many tasks such as viewing and replying to email, surfing the internet, and consuming content, such as music and video.

Each of the above devices has distinct advantages over the other, depending on the contemplated use. Desktops typically have more computing power, larger storage devices than laptops, but are bulkier, and destined for permanent (inasmuch as a permanent computer exists) installation. Laptops usually are quite powerful, have more modest storage devices, but gain in portability. Netbooks are essentially laptops with some features absent, such as an optical drive to read CD-ROM, DVD and/or BD-ROM disks, but have smaller screens than laptops and are therefore lighter and smaller.

Touchpads have recently been introduced, and are even smaller and lighter than netbooks, have the usual connectivity attributes (wireless networking, Bluetooth connectivity, and even 3G/4G capabilities, i.e. the ability to transmit and receive data within a cellular network), but run operating systems (OS) that are more limited than those running on the PC platform. Therefore, the software that one can “load” onto a touchpad is less complex than equivalent software running on a PC. This software is usually denoted “apps”, and these are specifically designed for the OS of the touchpad, and are usually more limited when it comes to features. That is not to say that these apps are not complex, but word processing software running on a PC will have far more features than an equivalent app running on a touchpad. This is in part due to the capacity of the processor loaded onto the touchpad, which capacity is driven in part by power consumption, or the desire to limit it. Indeed, touchpads are designed to be light and highly portable, which means that the battery must be smaller, and the onboard components draw as little power as possible in order to prolong battery life. The literature, both scientific and mass media, abounds with comparisons between these various devices, the design constraints that drive their development, and the resulting consumer satisfaction.

Users who are called upon to travel usually require a device which can accommodate their needs: email, internet access, sufficient computing power to run desired software, display size, and input/output devices (i.e. keyboard, mouse, audio, video, card slots and more advanced ports such as eSATA, HDMI, USB, etc.)

In addition to performing the usual work and entertainment related tasks, the device must also sometimes be capable of interacting with external devices, such as a projector, for projecting onto a screen. Although progress has been made in the last few years regarding interoperability of desktops/laptops/netbooks with external projectors, it does require an additional component. In addition, the user wishing to travel with an external projector faces increased weight and bulk challenges.

### SUMMARY OF THE INVENTION

It is an object of the invention to provide a fully integrated portable and entertainment device.

In accordance with an aspect of the invention, there is provided a portable, integrated computing device, comprising: a housing having a front, a back, a top and a bottom and two opposite sides. The device includes a PC board within the housing and a projector assembly operatively connected to the PC board. At least one input/output port is provided on the housing and operatively connected to the PC board. A display is located on a top portion of the housing. Instead of a physical keyboard, the invention provides for a virtual keyboard module, operatively connected to the PC board, for projecting an image of a keyboard on a surface, and for recognizing which key has been pressed on the image of the keyboard. The unit can be turned on with a selectable actuator for turning on said device. A lens of the projector assembly is located at the front of the housing. The selectable actuator is adapted to selectively operate the device as a projector, by connecting a source component to one of the at least one output port on the housing, and bypassing the PC board, in order to project an image through the lens of the projector assembly or to operate the device as a computing device, by powering the PC board, and by using either the projector for displaying images or using the display for displaying images, or both.

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic representation of the visual appearance of a device according to a preferred embodiment of the invention;

FIG. 2 is a side perspective view of the device of the invention according to a preferred embodiment, with a docking port on a top surface;

FIG. 3 is a block diagram of the architecture of the device;

FIG. 4 is an inside cut-out view of the device;

FIG. 5 shows a rear view of the device, with a virtual keyboard projected onto a surface;

FIG. 6 shows the approximate location of the keyboard image in relation to the device itself;

FIG. 7 is a view of the device, where an image is projected onto a surface and on the screen; and

FIG. 8 is a view of the device used as a projector only, with an external source.

### DESCRIPTION OF A PREFERRED EMBODIMENT OF THE INVENTION

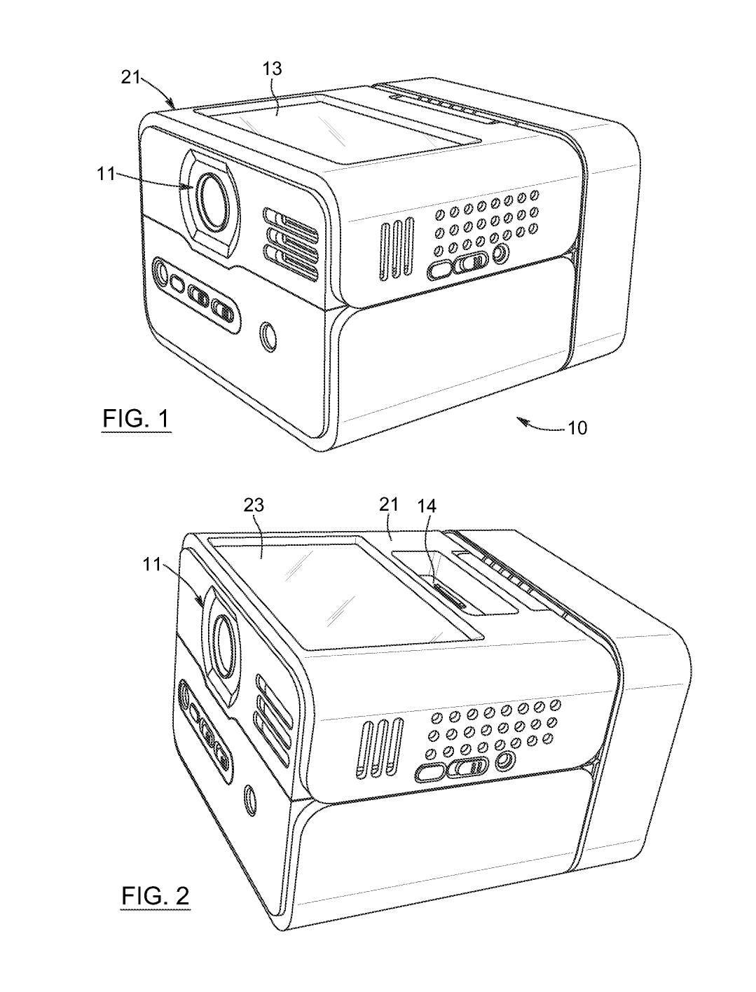

Referring now to FIG. 1, there is shown a device 10 according to a preferred embodiment of the invention.

The device 10 is a fully integrated computing and entertainment device. Device 10 is built around a computer platform, preferably a small form factor computer platform. Such computer platforms are commercially available. The computer platform is preferably adapted to run a Windows-based operating system (OS), but a person skilled in the art will appreciate that MacOS and Unix operating systems are also within the scope of the present invention, as are other OS.

The device 10 includes a built-in projector 11, and I/O ports 12. The device further includes a built-in display 13.

As shown in FIG. 2, the device 10 is comprised of a single unit. The projector 11 is located at the front of the unit, and is adapted to project an image size up to 88 inches.

A top portion 21 of the unit is hingedly connected to the unit 10. This top portion includes a display 13, which is preferably an LCD screen. The top portion may also include a docking port 14, for example for an iPod®, or other similar devices.

The projector is adapted to project images generated by the device itself, or may be used as an external projector. Therefore, the device includes at least an input 12, which can be an HDMI input, but could be DVI, component, RS232, etc.

The projector in its current embodiment projects up to 80 lumens, and can project an image format of up to 104 inches in a 16:9 ratio. A person skilled in the art will appreciate that images with a 4:3 ratio can also be displayed.

The device 10 does not include a formal, hard keyboard. Instead, the device 10 is provided with a virtual keyboard projector 30. The virtual keyboard projector 30, as is known in the art, consists of an IR sensor 31, a camera sensor 33, a laser device 35, at least one, preferable two, optic systems 37. The laser device is adapted to project an image of a keyboard 32 onto a surface. When the user “types”, the IR and camera sensors work together to detect which key has been “pressed”.

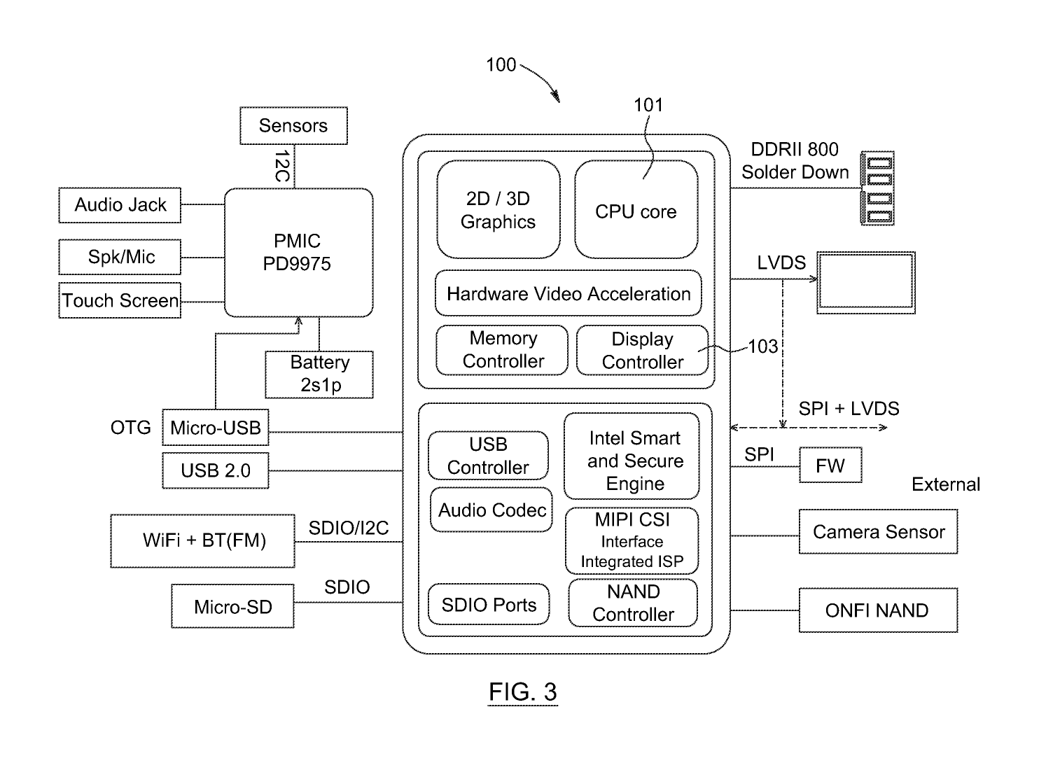

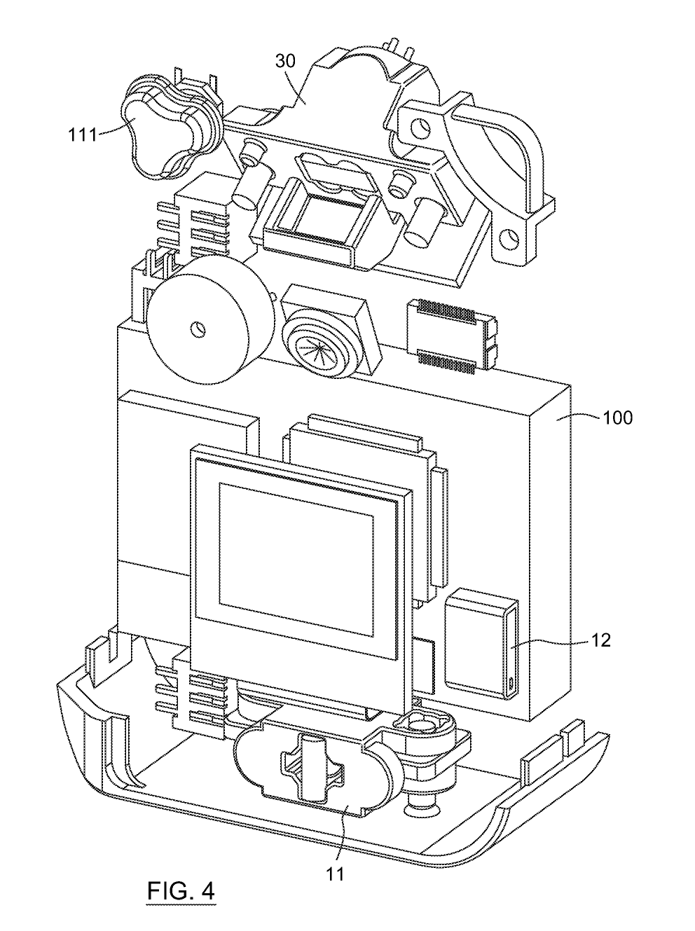

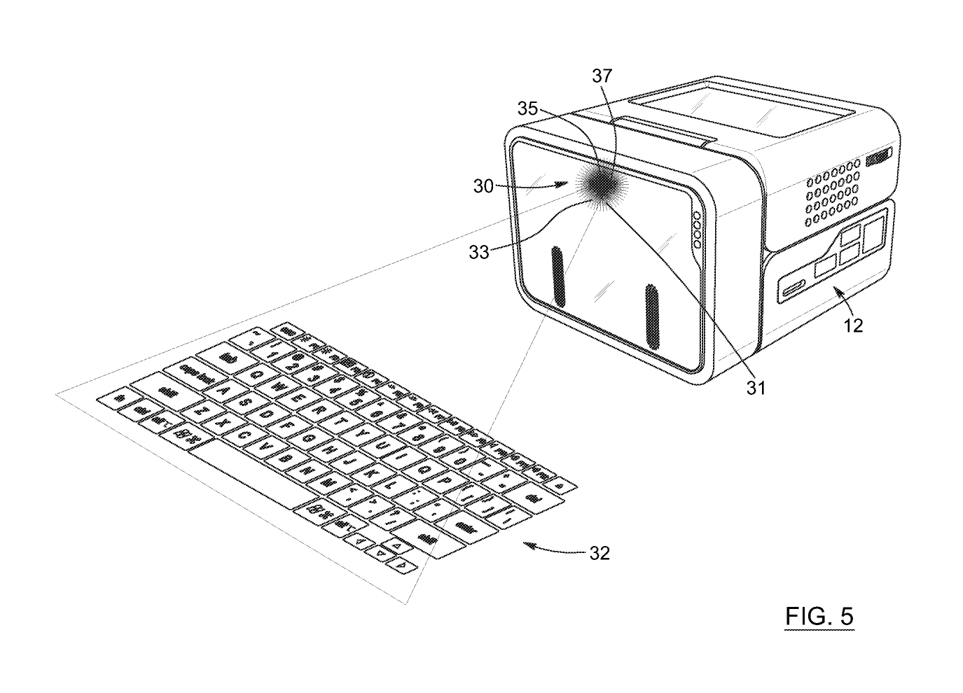

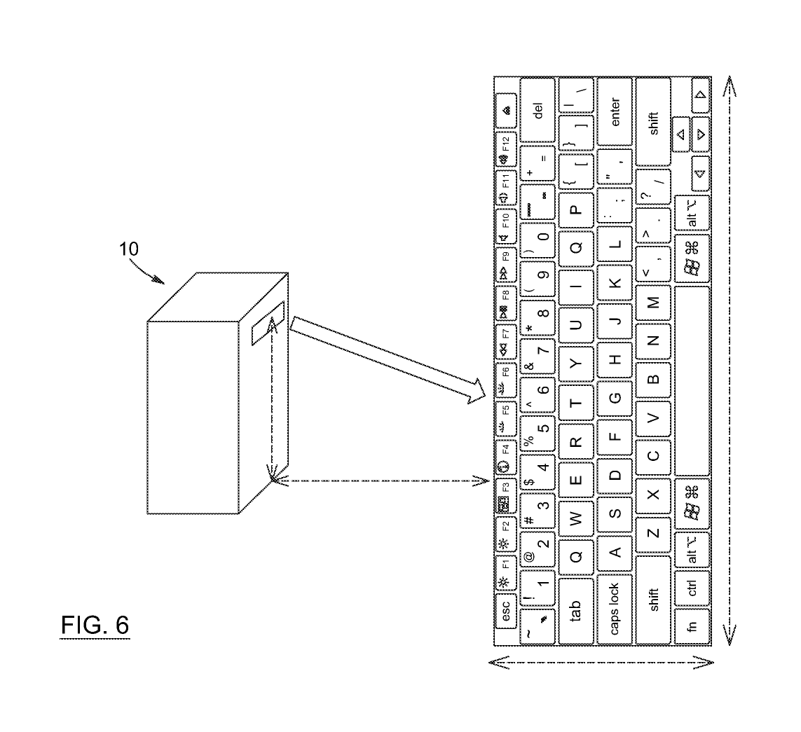

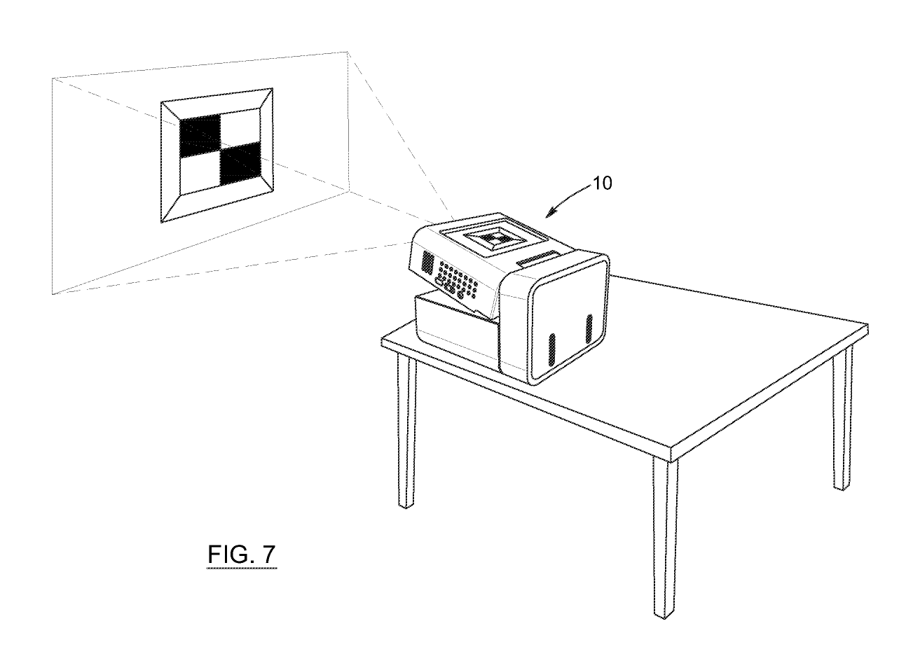

Referring now to FIG. 3, in a preferred embodiment, the device 10 is constructed around a PC board 100 which has an onboard CPU 101, memory, and graphics adapter 103. The PC board is further complemented by an array of I/O ports and communication ports, such as USB, micro-USB, HDMI, audio in/out, WIFI, Bluetooth, Ethernet, Flash card reader, loudspeaker, touch screen, etc. In a preferred embodiment, the PC board is built around an Intel iCore 5 or iCore 7 platform.

The device is powered by a power button 111, which is preferably a hard power button in the form of a toggle switch. The device can be powered in one of three modes: projector only, computer only or computer and projector. This allows the computer to run independently of the projector. The OS will boot upon power up, and project a screen image either via the LCD screen or the projector, or may even use both. The virtual keyboard and virtual mouse can be used for input to the system, or external keyboard and mouse devices can be plugged in through the USB ports, for example. The device includes internal speakers, but external speakers can also be connected to the device provided the appropriate sound card interface is provided.

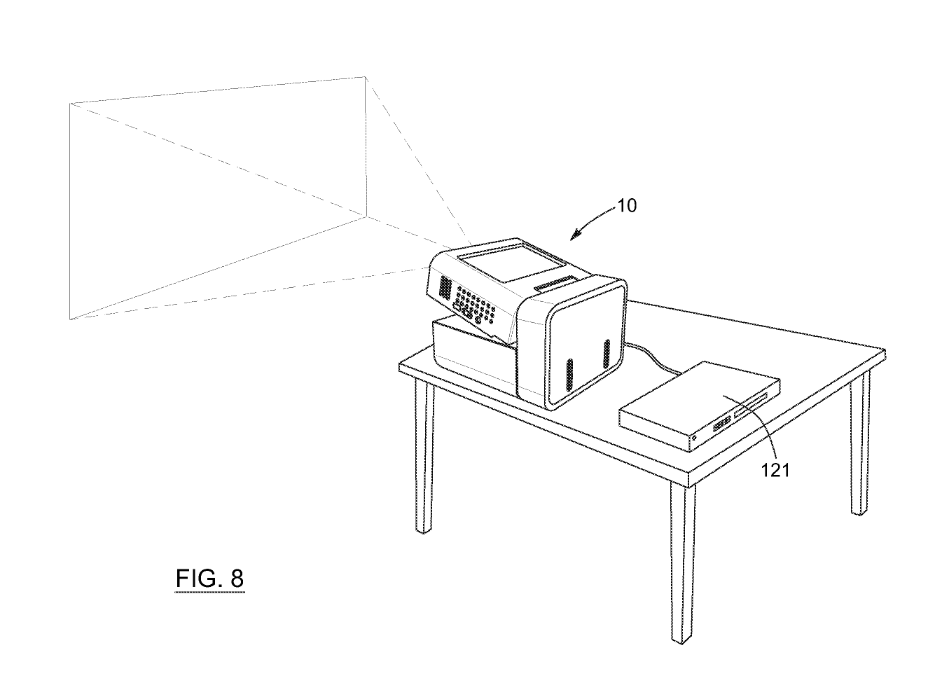

It will be appreciated that the system can be used as a complete computer, as shown in FIG. 7 or used only as a projector, permitting external hook-ups such as gaming consoles, video devices such as DVD or Blu-Ray players, other computers, etc., as shown in FIG. 8.

The reader will appreciate that the specifications outlined in the present document are for illustration purposes only, and that technological advances in performance form part of the present invention. For example, the projector has been described as having a certain output power (lumens). However, more powerful projectors that may be developed will be able to be integrated into a device according to the present invention without departing from the scope of the invention as defined in the claims.

The present invention therefore provides a compact, standalone projector with built-in computing capabilities. The device of the invention is also versatile in that it can accommodate a variety of external devices.

Although the present invention has been explained hereinabove by way of a preferred embodiment thereof, it should be pointed out that any modifications to this preferred embodiment within the scope of the appended claims is not deemed to alter or change the nature and scope of the present invention.

1. A portable, integrated computing device, comprising:
a housing having a front, a back, a top and a bottom and two opposite sides, a PC board within the housing;
a projector assembly operatively connected to said PC board;
at least one input/output port on said housing and operatively connected to said PC board;
a display located on a top portion of said housing;
a virtual keyboard module, operatively connected to said PC board, for projecting an image of a keyboard on a surface, and for recognizing which key has been pressed on said image of said keyboard; and
a selectable actuator for turning on said device,
wherein
a lens of said projector assembly is located at the front of said housing; and
said selectable actuator is adapted to selectively operate said device as a projector, by connecting a source component to one of said at least one output port on said housing, and bypassing said PC board, in order to project an image through said lens of said projector assembly or to operate said device as a computing device, by powering said PC board, and by using either the projector for displaying images or using the display for displaying images.

2. A device according to claim 1, wherein said lens and said display are each located on a portion of said housing that is hingedly connected to said housing about a transverse axis, permitting pivoting said display vertically towards a user.

3. A device according to claim 1, wherein said at least one input/output port includes an HDMI port, a DVI port, a USB port, an audio out port, a FireWire port, an Ethernet port or a flash card reader port.

4. A device according to claim 3, wherein said device includes a plurality of input/output ports.

5. A device according to claim 1, wherein said display is a touch screen.

6. A device according to claim 1, wherein said portion of said housing that is hingedly connected further includes a docking port for a personal computing device.

7. A device according to claim 6, wherein said docking port is an iPod port.

8. A device according to claim 1, wherein said device further comprises wireless connectivity modules.

9. A device according to claim 8, wherein said wireless connectivity modules include WiFi, NFC, Bluetooth or cellular telephone capability.
